(19) United States
(12) Patent Application Publication
(10) Pub. No.: US 2002/0005106 A1
(43) Pub. Date: Jan. 17, 2002

(54) Percussion instrument

(76) Inventor: Wolfgang Payerl, Muenchsteinach (DE)

Correspondence Address: BROWDY AND NEIMARK, P.L.L.C., 624 NINTH STREET, NW, SUITE 300, WASHINGTON, DC, 20001-5303, US

(21) Appl. No.: 09/901,655

(22) Filed: Jul. 11, 2001

(30) Foreign Application Priority Data
Jul. 15, 2000 (DE) 100 34 535.2

(51) Int. Cl. G10D 13/02

(52) U.S. Cl. 84/411 R

(57) ABSTRACT

In a percussion instrument such as a drum, tambourine, bongo, conga or the like, comprising a main body with at least one opening over which a skin is stretched that is to be struck, it is provided, with a view to obtaining novel sound variations and possibilities of playing, that at least one web is fixed in particular off-center underneath the skin, bearing there against and bridging the opening crosswise.

### BACKGROUND OF THE INVENTION

1. Field of the Invention

The invention relates to a percussion instrument such as a drum, tambourine, bongo, conga or the like, comprising a main body with at least one opening over which a skin is stretched that is to be struck.

2. Background Art

In the following, the term skin is to be understood in the widest sense. It includes a natural skin as well as a foil of plastic material, combinations of foils or other suitable materials.

The idea is that the skin is struck for playing and set vibrating, the vibrations being amplified and emitted by the resonance body of the percussion instrument.

For sounds of varying pitches to be obtained, skins and resonance bodies of varying diameters are used. The sound of the instrument may also be influenced by the tautening of the skin.

### SUMMARY OF THE INVENTION

It is the object of the invention to further develop a percussion instrument of the type mentioned at the outset so that novel sound variations and possibilities of playing present themselves.

According to the invention, this object is attained by at least one web being fixed off-center underneath the skin, bearing against the skin and bridging the opening crosswise.

Such a web divides the skin into two sections of a larger and a smaller surface which, when struck separately, give varying pitches although one and the same resonance body is used.

In keeping with another embodiment of the invention, provision can be made for a damping strip of a comparatively soft material to be disposed between the upper side of the web and the lower side of the skin.

Furthermore, it can be provided that the web is adjustable in height and/or detachable. By the aid of height adjustment, the pressure against the skin may be modified or the web may be disengaged when the instrument is to be played conventionally.

Details of the invention will become apparent from the ensuing description of a preferred embodiment, taken in conjunction with the drawing.

### BRIEF DESCRIPTION OF THE DRAWING

FIG. 1 is a perspective view of a drum according to the invention in the form of a timbale; and

FIG. 2 is an illustration of details on an enlarged scale.

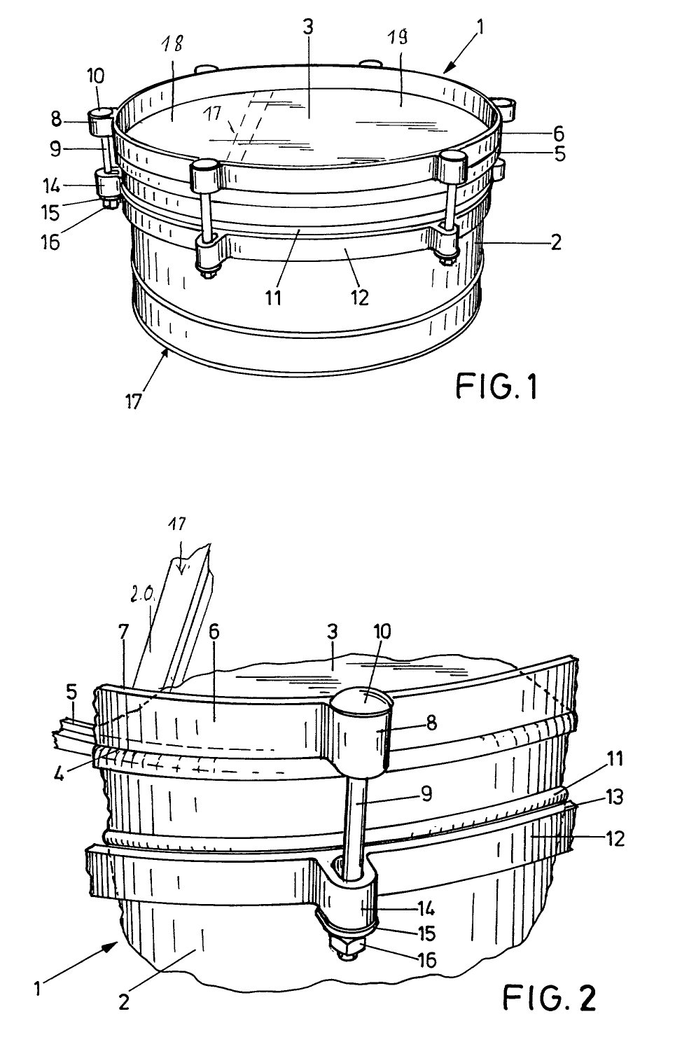

### DESCRIPTION OF THE PREFERRED EMBODIMENT

As seen in the drawing, a drum 1 includes a substantially cylindrical main body 2, over the upper side of which a skin 3 is stretched by way of a holding ring 5, which is underneath the skin and therefore not seen in the drawing and which has an encircling lateral shoulder 4.

A first clamping ring 6 corresponds in cross section to the space recessed by the shoulder 4 so that it can be shifted over the periphery of the skin 3 and placed on the shoulder 4 in such a way that its upper edge 7 projects over the skin and the vertical outside is in alignment with the part of the holding ring 5 underneath the shoulder 4.

Several tensioning lugs 8 are welded on the first clamping ring 6 at a distance from each other. Straining screws 9 are inserted in these tensioning lugs 8, with the head 10 of the straining screws 9 resting on the upper side of the tensioning lugs 8.

In the vicinity of the holding ring 5 for the skin 3, the main body 2 has an encircling annular bead 11 in the form of a bulge of the main body 2 which is a sheet metal cylinder.

A second clamping ring 12 encircles underneath the annular bead 11, resting by its upper edge 13 on the annular bead 11. The second clamping ring 12 has a plurality of tensioning lugs 14 having the same angular distance as the tensioning lugs 8 of the first clamping ring 6.

The straining screws 9 pass downwards through the second tensioning lugs 14, with a shim 15 and a nut 16 being placed on the free lower end of the straining screws 9.

When the nuts 16 are tightened, the first clamping ring 6 and thus the holding ring 5 are clamped against the second clamping ring 12 which bears against the annular bead 11.

As a result of this construction, the tensile forces are distributed around the main body 2, acting thereon totally uniformly. Consequently local tensile loads are avoided.

Another skin may be stretched over the free end 17 in the same way as the skin 3 described above.

According to the invention, provision is made for a web 17 which extends crosswise of the upper opening of the main body 2 that constitutes the resonance body, dividing the skin 3 into a small-surface section 18 and a large-surface section 19.

A damping strip 20 of a soft felt material is disposed on the upper side of the web 17.

When the small-surface section 18 is struck, the sound obtained is higher than that obtained when the large-surface section 19 is struck.

What is claimed is:

1. A percussion instrument such as a drum, tambourine, bongo, conga or the like, comprising a main body with at least one opening over which a skin is stretched that is to be struck, wherein at least one web (17) is fixed in particular off-center underneath the skin (3), bearing there against and bridging the opening crosswise.

2. A percussion instrument according to claim 1, wherein a damping strip (20) of a comparatively soft material is disposed between the upper side of the web (17) and the lower side of the skin (3).

3. A percussion instrument according to claim 1, wherein the web (17) is at least one of adjustable in height and detachable.
